(19) United States
(12) Patent Application Publication
(10) Pub. No.: US 2005/0279144 A1
(43) Pub. Date: Dec. 22, 2005

(54) Closure panel lock and opener handle

(76) Inventor: Horst Kutschat, Wuppertal (DE)

Correspondence Address: BRINKS HOFER GILSON & LIONE, P.O. BOX 10395, CHICAGO, IL, 60610, US

(21) Appl. No.: 11/063,345

(22) Filed: Feb. 25, 2005

(30) Foreign Application Priority Data
Feb. 26, 2004 (DE) 10 2004 009 366.0

(51) Int. Cl. E05B 13/10

(52) U.S. Cl. 70/210

(57) ABSTRACT

The invention relates to an actuating apparatus for a lock mechanism, in particular of a door or panel of a motor vehicle having a handle body, in which an actuating device for driving an actuating element for the lock mechanism is mounted in a handle-body end region. A moveable coupling link is provided, with which the actuating device can be brought out of operation, the coupling link being connected driveably to a locking device having a remote-controllable driving device.

The invention relates to an actuating apparatus for a lock, in particular a door lock and/or flap lock of a motor vehicle, in particular of a tractor, according to the preamble of claim 1.

Known actuating apparatuses for motor vehicle locks have a handle body, in which a pushbutton with a lock cylinder is mounted displaceably. The pushbutton can be transferred from a first operating state into a second operating state and vice versa by means of a key which fits into the lock cylinder. In the first operating state, a lock can be actuated by means of the push-button, so that it opens. In the second operating state, the pushbutton, when actuated, executes an “empty stroke”, so that despite the button being pressed, an actuation, i.e. an opening of the lock, does not occur. The associated motor vehicle door or motor vehicle flap is therefore locked.

Furthermore, it is known to enable the locks to interact with a remote-controllable locking unit, for example within the context of a central locking system of the motor vehicle. In the case of known arrangements of actuating apparatus and lock together with a remote-controllable locking unit, it is disadvantageous that a large amount of space is a necessity and a multiplicity of parts and a high structural outlay are required. Furthermore, it is expensive and laborious to install and secure the components.

It is the object of the invention to provide an actuating apparatus for a lock, in particular a motor vehicle door lock or flap lock, in particular for a tractor, which does not need much space and has a remote-controllable locking and/or unlocking functionality.

This object is achieved by an actuating apparatus having the features of claim 1. Advantageous embodiments are indicated in the subclaims which are dependent thereon.

The invention is described below by way of example with reference to the drawing, in which:

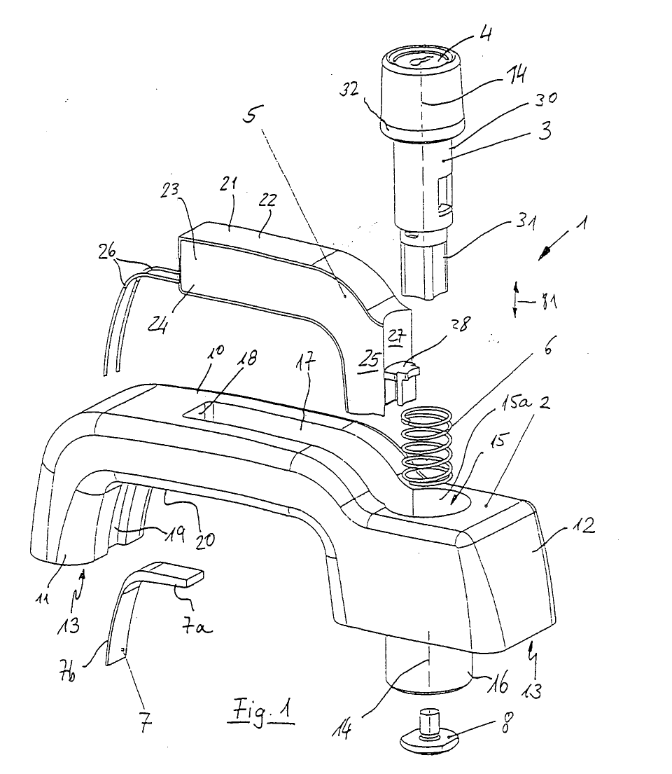

FIG. 1 shows a perspective exploded illustration of an actuating apparatus according to the invention;

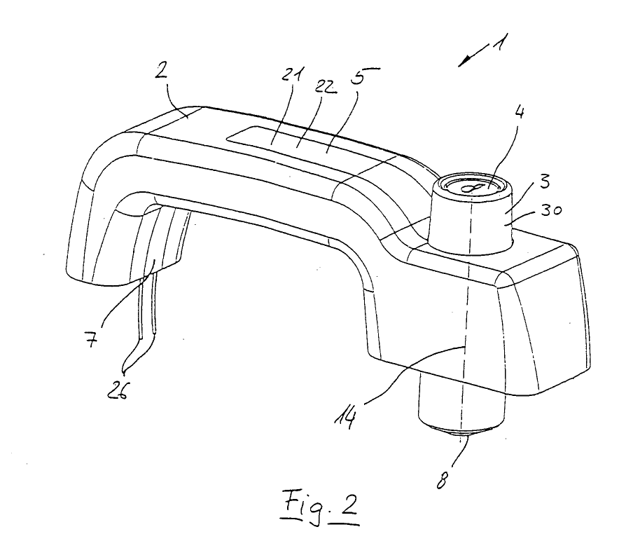

FIG. 2 shows the actuating apparatus according to FIG. 1 in a perspective assembly illustration;

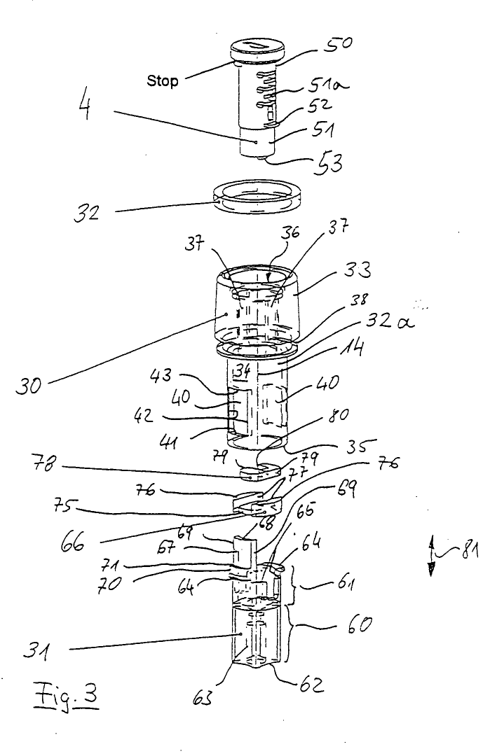

FIG. 3 shows a perspective exploded illustration of a pushbutton of the actuating apparatus according to FIG. 1;

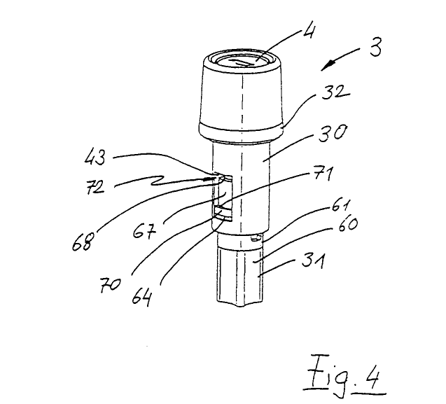

FIG. 4 shows a perspective assembly illustration of the pushbutton according to FIG. 3;

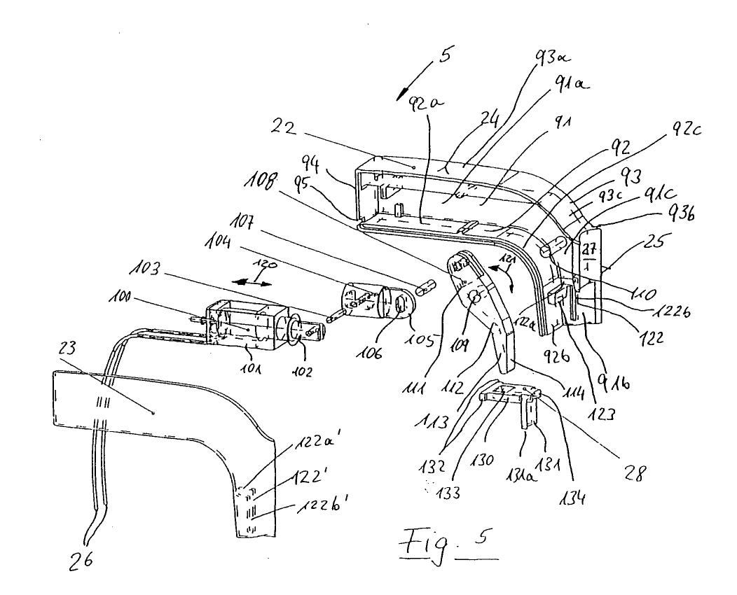

FIG. 5 shows a perspective exploded illustration of a locking device of the actuating apparatus according to the invention according to FIG. 1;

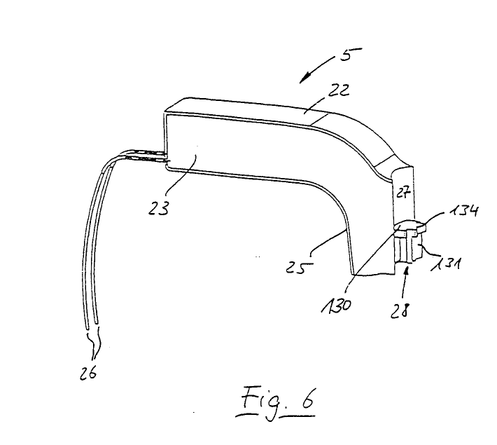

FIG. 6 shows the locking device according to FIG. 5 in a perspective assembly illustration;

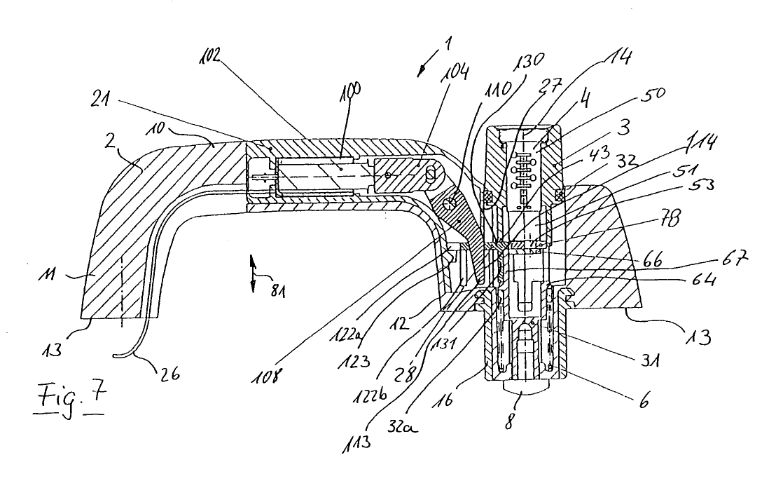

FIG. 7 shows a longitudinal section through the actuating apparatus according to FIG. 1 in a first operating position with the push-button not actuated;

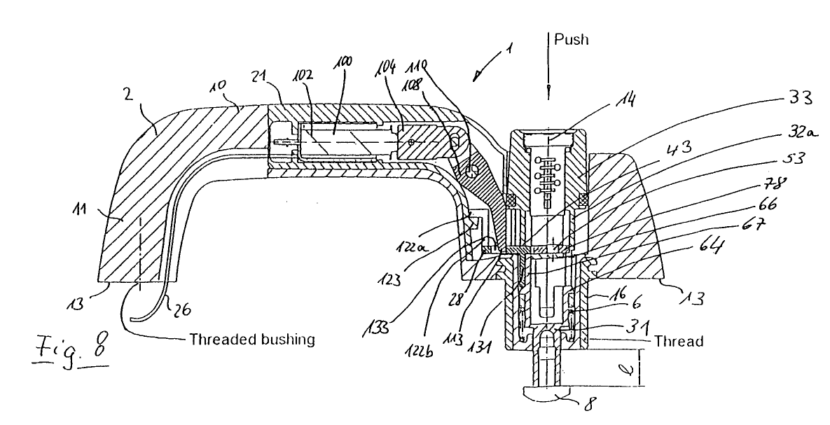

FIG. 8 shows the actuating apparatus according to FIG. 7 with the pushbutton actuated;

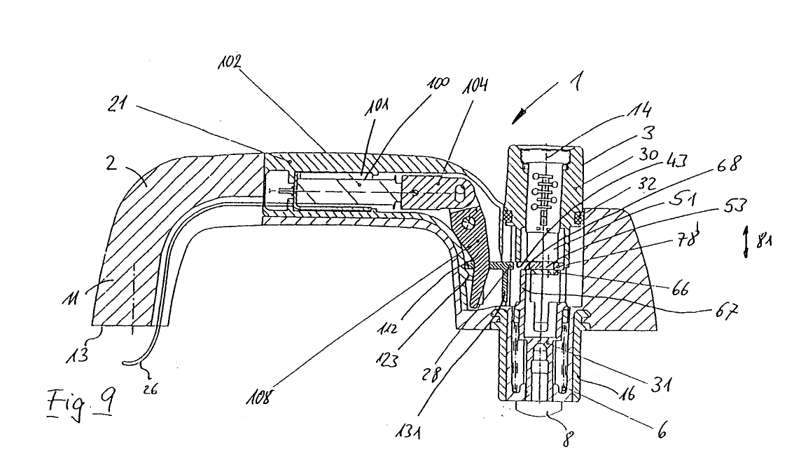

FIG. 9 shows a longitudinal section through the actuating apparatus according to the invention in a second operating position with the pushbutton not actuated;

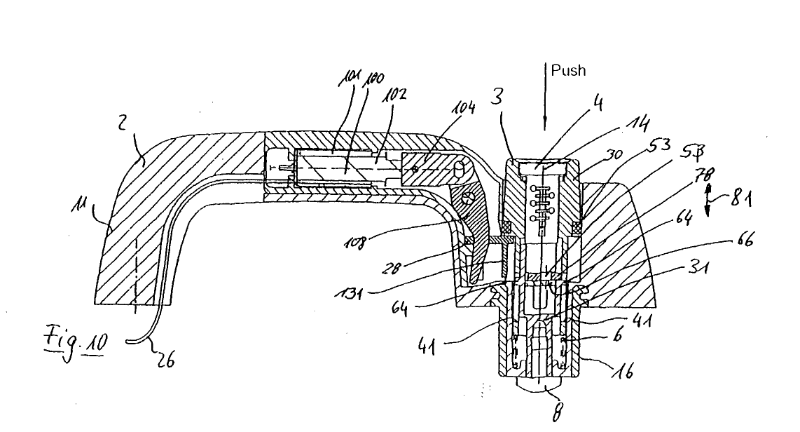

FIG. 10 shows the actuating apparatus according to FIG. 9 with the pushbutton actuated.

An actuating apparatus 1 according to the invention (FIG. 1) has a handle body 2, and as actuating device a pushbutton 3 with a lock cylinder 4, a motor-driveable locking device 5, a compression spring 6, and a covering 7 and an actuating element 8.

As viewed from the side, the handle body 2 is designed as an essentially U-shaped handle bracket, with a base limb 10, a first U-limb 11 and a second U-limb 12. The U-limbs 11, 12 each have end sides 13 with which the handle body 2 can be fastened, for example, to a door outer skin of a motor vehicle. The second U-limb 12 has, along an actuating longitudinal axis 14, which extends in the limb direction and is also the longitudinal movement axis of the pushbutton 3 together with the lock cylinder 4, a plug-in opening 15 for the pushbutton 3. The plug-in opening 15 opens into a plug-in channel 15a which completely penetrates the second U-limb 12. A bushing-shaped receiving device 16 which has an essentially cylindrical outer shape extends from the end side 13 of the second U-limb 12. An elongate groove or a blind-hole recess 17 extends away from the plug-in opening 15, and opening into the latter and to the outside, to over approximately ⅔ of the base limb 10, said elongate groove or blind-hole recess following the contour of the U-limb 12 and of the base limb. The blind-hole recess 17 in the base limb 10 is connected in the region of its end 18 lying opposite the plug-in opening 15, just above its groove base, to a groove-type depression 19 or a groove, which is open opposite or extends from an inside 20 of the base limb 10 and of the first U-limb 11 as far as the end side 13 of the first U-limb 11, or said blind-hole recess 17 follows the contour of these parts. The groove-type depression 19 can be covered or can be closed by means of the covering 7, which is of essentially L-shaped design with a first covering limb 7a and a second covering limb 7b.

The locking device 5 is designed in the manner of a plug-in module for plugging into the blind-hole recess 17 of the handle body 2 and has a cross-sectionally rectangular housing 21 with a housing main part 22 and a lateral housing cover 23. As viewed from the side, the housing 21 is of essentially L-shape design and has a first, longer L-limb 24 and a second, shorter L-limb 25. The first limb 24 corresponds to the blind-hole recess 17 in the base limb 10. The second limb 25 corresponds to the blind-hole recess 17 in the region joining the latter to the plug-in opening 15, and, in the assembled state, comes to lie in the transition region between the second U-limb 12 and the base limb 10. Electric lines 26 lead off at the free end of the first limb 24. The second limb 25 has, toward the plug-in opening 15, an outer surface 27 which is designed in the shape of a section of a concave cylinder, such that the plug-in opening 15 together with the outer surface 27 is circular in cross section. A projecting slide 28, which is described in more detail further below, projects from the outer surface 27 of the locking device 5 for a distance into the plug-in opening 15.

The pushbutton 3 has a pushbutton upper part 30 and a pushbutton lower part 31. The lock cylinder 4 sits in the pushbutton upper part 30 by means of a clip connection. A sealing ring 32 which interacts with the inside of the plug-in opening 15 and seals off the gap between the pushbutton upper part 30 and the plug-in opening 15 is arranged on the outside of the pushbutton upper part 30.

In the following, the construction of the pushbutton 3, which together with the actuating element 8 forms an actuating device, together with the lock cylinder 4 will be described in more detail with reference to FIGS. 3 and 4. The pushbutton upper part 30 has a cylindrical tube section 32a and a compressive part 33. The cylindrical tube section 32a is a thin-walled, cylindrical tube with a tube outside 34 and a free annular end surface 35. Opposite the annular end surface 35, the compressive part 33 is connected integrally to the cylindrical tube section 32a. The compressive part 33 is larger in outside diameter than the cylindrical tube section 32a and has a stepped hole 36 with the actuating longitudinal axis 4 as the central axis. The stepped hole 36 has longitudinal grooves 37 on the inside for receiving small lock plates of the lock cylinder 4. On the outer circumference, the compressive part 33 has, adjacent to the cylindrical tube section 32, an annular groove 38 for receiving the sealing ring 32.

The cylindrical tube section 32a has opposite, rectangular window-type cutouts 40 with a lower edge 41, two side edges 42 and an upper edge 43. The two window-type cutouts 40 have the same extent in terms of area. The lower edge 41 and the upper edge 43 are each parallel to the annular end surface 35. The side edges 42 are parallel to the actuating longitudinal axis 14.

The lock cylinder 4 has a blocking body 50 and a rotating body 51. Small lock plates 51 are mounted in a known manner in the blocking body 50. Furthermore, the blocking body 50 has a tumbler 52 as a means of securing it against falling out, said tumbler being intended in a known manner to prevent the blocking body 50 from rotating in the compressive part 33. The rotating body 51 has, eccentrically with respect to the actuating longitudinal axis 14, an eccentric nipple 53 which protrudes downward for a distance in the axial direction from the rotating body 51.

The pushbutton lower part 31 has a punch section 60 and a tube section 61. The punch section 60 has, along the actuating longitudinal axis 14, at the free end 62 of the punch section 60, a threaded hole 63 for receiving the actuating element 8. The tube section 61 has an outside diameter which corresponds to the inside diameter of the cylindrical tube section 32a of the pushbutton upper part 30. The tube section 61 extends away for a distance from the punch section 60 and, corresponding to the window-type cutouts 40, has latching projections 64 which are dimensioned, with regard to their three-dimensional shape, in such a manner that they can interact in a latching manner with the lower edge 41 of the window-type cutouts 40. With regard to the width, the latching projections 64 are dimensioned in such a manner that they can be moved up and down in the window-type cutouts 40 guided by the side edges 42. Adjacent to the latching projections 64, the tube section 61 has end steps 65 situated somewhat lower down. The end steps 65 serve to support a slide guide 66 which is described in more detail further below. Aligned in the longitudinal direction, one of the latching projections 64 has a stop tab or stop web 67 as an extension of the tube section 61 upward. The stop tab 67 has a three-dimensional shape in the form of a section of a cylindrical tube wall, and has an upper, free end edge 68 and side edges 69. Directly in the longitudinal axial direction 14 adjacent to the associated latching projection 64, the stop tab 67 has an outwardly projecting, curved stepped shoulder 70 which has a step upper side 71 in the form of a section of a circular ring. In the assembly of the pushbutton upper part 30 and of the pushbutton lower part 31, the stepped shoulder 70 is situated in one of the windows 40 of the pushbutton upper part 30 (cf. FIG. 4). The axial extent of the stop tab 67 is dimensioned in such a manner that, in the assembly, when the latching projection 64 bears against the lower edge 41 of the window 40, there is an axial distance between the free end edge 68 and the upper edge 43, so that a clearance or gap 72 is formed (cf. FIG. 4).

The slide guide 66 (cf. FIG. 3) has a base plate 75 which is essentially in the form of a circular disk and the outside diameter of which corresponds approximately to the inside diameter of the tube section 60. Spaced apart opposite one another, circular disk segments 76 are integrally formed on the base plate 75 and have an outside diameter which corresponds to the outside diameter of the tube section 61 or the inside diameter of the cylindrical tube section 32a. The circular disk sections 76 are of thicker design than the base plate 75 and have opposite, parallel, plane guide surfaces 77 which, together with the base plate 75, serve for the displaceable mounting of a slide 78 which will be described in more detail further below. The base plate 75 therefore forms, together with the guide surfaces 77, a cross-sectionally u-shaped guide groove for the slide 78.

The slide 78 is a first coupling link and has a three-dimensional form essentially in the shape of a disk and has rectilinear, opposite guide edges 79 which interact with the guide surfaces 77, so that guiding of the slide 78 between the circular disk sections 76 is ensured. The end edges of the slide 78 are in the form of a circular arc. The outside diameter of the slide 78 between the end edges corresponds to the inside diameter of the cylindrical tube section 32a. A u-shaped recess 80 extends from one of the guide edges 79 into the interior of the slide 78. In the assembly, the eccentric nipple 53 of the lock cylinder 4 engages in this u-shaped recess 80. In the assembly, the slide guide 66 sits with the circular disk sections 76 on the end steps 65 of the tube section 61. The slide guide 66 can be displaced together with the slide 78 or the pushbutton lower part 31 in a double arrow direction or axial direction 81 (FIG. 10), the slide guide 66 being guided along the free side edges 69 of the stop tab 67.

The construction of the locking device 5 according to the invention will be described in detail below with reference to FIGS. 5 and 6.

The housing part 22 has a three-dimensional shape which, as viewed from the side, is essentially L-shaped and U-shaped in cross section, with a housing base wall 91, a first, L-shaped side wall 92 and a second, L-shaped side wall 93 and an end side wall 94. The second side wall 93 has the outer surface 27 in the region of the plug-in opening 15, which outer surface, together with the plug-in opening 15, forms a cross-sectionally circular passage. The base wall 91 has, in the region of the long limb 24, a first, long base wall section 91a and, in the region of the second, short limb 25, a second, short base wall section 91b. The base wall sections 91a and 91b merge one in the other with a base wall curved section 91c.

The first side wall 92 has a first, long side wall section 92a in the region of the first, long limb 24, a second, short side wall section 92b in the region of the second, short limb 25 and a side wall curved section 92c in between. The second side wall 93 has a first, long side wall section 93a in the region of the first, long limb 24, a second, short side wall section 93b in the region of the second, short limb 25 and a side wall curved section 93c in between, the first, long side wall section 93a and the side wall curved section 93c together in the assembly forming a surface which is aligned with the surface of the handle body 2.

In the assembly, the end side wall 94 bears flush against the free end 18 of the blind-hole recess 17. The end side wall 94 has, in the region of the side wall 92, two recesses 95 through which the electric lines 26 can be led out of the housing interior.

A motor axial drive 100, for example a lifting magnet with a magnet body 101 and a piston rod 102, which is guided in a central hole and protrudes out of the hole, is arranged in the region of the first limb 24. The piston rod 102 is connected outside the magnet body 101 via a transverse pin 103 to a drag lever or drag arm 104 which sits in front of the head on the piston rod. The drag lever 104 has, in the region of its free end 105, a slot-type recess 106 which extends perpendicularly with respect to the longitudinal extent and in which is mounted a pin 107 which extends transversely with respect thereto and via which the drag lever 105 is connected to a lever arm 111 of a two-armed reversing lever 108. The reversing lever 108 has a hole 109 with which it is mounted pivotably on an axis 110 which extends away vertically from the base wall 91 in the region of the base wall curved section 91c. The reversing lever 109 has a second lever arm 112 lying opposite the first lever arm 111. The axial drive 100, the drag lever 104 and the first lever arm 111 of the reversing lever 108 are arranged in the region of the first limb 24 of the housing 21. The second lever arm 112 of the reversing lever 108 protrudes from the axis 110 into the second limb 25 of the housing 21. The reversing lever 108 has an actuating section 113 in the region of the free end of the second lever arm 112. The actuating section 113 tapers toward the free end and has a sliding surface 114 which points in the assembly toward the plug-in opening 15. Axial extension of the axial drive 100 in a direction 120 causes the reversing lever to pivot via the drag lever 104 about the axis 110 in a direction 121.

The second base wall section 91b has a rectangular, L-shaped angled groove 122 with a first, short groove limb 122a and a second, long groove limb 122b. The first groove limb 122a runs parallel to the actuating direction 120 of the axial drive 100. The second groove limb 122b runs parallel to the actuating longitudinal axis 14. At the free end of the first groove limb 122a, the latter ends in the transition region between the base wall section 92c and the second side wall section 92b of the side wall 92. A stop console 123 for the slide 28, which will be described further below, is integrally formed, laterally aligned with the groove limb 122a, on the inside of the second side wall section 92b. Opposite the second side wall section 92b, the side wall section 93b has, below the outer surface 27, a recess from which the slide 28 protrudes.

The slide 28 is a further coupling link and has a slide plate 130 and a stop tab or stop web 131 which, perpendicularly from the slide plate 130, extends away from the end of the slide plate 130 in the region of one end thereof. The stop tab 131 has a free edge 131a and has a width which is smaller than or equal to the clear width of the windows 40. In the region of the other end of the slide plate 130, a projection 132 is integrally formed on each side of the slide plate 130. In the assembly, the projections 132 run in the angled groove 122, i.e. they are in engagement with the angled groove limbs 122a and 122b. Opposite the angled groove 122 in the base wall 91, an angled groove 122′ with a first angled groove limb 122a′ and a second angled groove limb 122b′ is likewise formed in the cover 23. The angled grooves 122 and 122′ serve for guiding the slide 130. In an operating position, the slide plate 130 rests on the supporting console 123. The slide plate 130 furthermore has an essentially square reach-through window 133 through which the free end 113 of the reversing lever 108 reaches. The stop tab 131 of the slide 28 has a three-dimensional shape which is in the form of a cylindrical tube wall and the inside diameter of which corresponds approximately to the outside diameter of the tube section 61 and the outside diameter of which corresponds approximately to the outside diameter of the cylindrical tube section 32a. As an extension of the slide plate 130, a slide projection 134 which has a channel in the form of a circular arc at its free end extends beyond the stop tab 131, the channel approximately corresponding in respect of its diameter to the inside diameter of the tube section 61.

The housing 21, in which the axial drive 100, the drag lever 104, the reversing lever 108 and the slide 28 are mounted, therefore form the locking driving device 5 which can be inserted into the handle body 2 in the manner of a module or cassette.

The assembly of the actuating apparatus 1 according to the invention will be described in more detail below with reference to FIG. 7 as a supplement to the previous description.

In the assembly, the compression spring 6 at one end is supported on a base wall of the receiving device 16 and at the other end rests against the annular end surface 35 of the cylindrical tube section 32a of the pushbutton upper part 30. The pushbutton lower part 31 is connected by means of the previously described clip connection to the pushbutton upper part 30 in a manner such that they can be displaced axially in the direction 81. The pushbutton upper part 30 is mounted in the handle body 2 by means of the sealing ring 32 in the plug-in opening 15 in interaction with the outer surface 27. The pushbutton lower part 31 reaches through a hole in the base wall of the receiving device 16 and is connected to the actuating element 8. The reversing lever 108 reaches with its free end 113 through the slide plate 130 of the slide 28, the slide 28 being guided in the grooves 122, 122, in the housing 21. The windows 40 of the pushbutton 3 are arranged in such a manner that the window 40, in which the stop tab 67 of the pushbutton lower part 31 is arranged, lies opposite the slide 28. The slide 78, which can be actuated manually via the lock cylinder 4, is in engagement with the eccentric nipple 53 of the lock cylinder 4 and can be displaced to and fro by means of the eccentric nipple 53 in a direction perpendicular with respect to the axis 14, for example by rotation of the lock cylinder 4 by a key.

In the following, a first operating position (“central locking system or locking device 5 open”) will be described with reference to FIGS. 7 and 8. In the position according to FIG. 7, the pushbutton 3 is not actuated and, in the position according to FIG. 8, it is actuated, i.e. pushed in.

According to FIG. 7, the axial drive 100, i.e. the lifting magnet, is energized, so that the push rod 102 is drawn in. In this position, the lever arm 112 of the reversing lever 110 is positioned in such a manner that the sliding surface 114 is oriented parallel to the actuating longitudinal axis 14. The slide 28 sits with its guide projections 132 in the corner region of the angled groove 122, so that the stop tab 131 of the slide 28 comes to bear against the stop tab 67 of the pushbutton lower part 31 and the free end edge 131a rests on the step 71. Furthermore, the upper edge 43 of the window 40, which faces the slide 28, in the pushbutton upper part 30 sits on the slide plate 130. In addition, the projection 134 rests on the free end edge 68 of the stop tab 67. The pushbutton upper part 30 is therefore connected to the pushbutton lower part 31, in a manner coupled in a form-fitting manner via the slide 28, said pushbutton lower part in turn being connected in a form-fitting manner to the actuating element 8, so that pressing on the compressive part 33 according to FIG. 8 causes the pushbutton upper part 30 together with the slide 28 and the pushbutton lower part 31 and the actuating element 8 to be displaceable by the length l (cf. FIG. 8). In this position, the slide 28 with its projections 132 is situated at the free end of the second groove limb 122b or 122b′. The compression spring 8 is compressed. Release of the compressive part 33 causes the compression spring 6 to expand and to bring the pushbutton 3 back into the starting position according to FIG. 7. Extension of the actuating element 8 by the length l causes a lock mechanism to be actuated (not illustrated).

In the second operating position according to FIGS. 9 and 10 (“central locking system” closed), the axial drive 100 or the lifting magnet 101 is connected currentlessly, so that the push rod 102 is extended. The actuating lever arm 112 of the reversing lever 108 is pivoted toward the console 123 and bears against the console 123. During the pivoting, it has carried along the slide 28 which, in the retracted position, rests in the free end of the groove limb 122a, with the slide plate 130 resting on the console 123. In this position, the stop tab 131 of the slide 28 is arranged spaced apart from the stop tab 67 of the pushbutton lower part 31, so that the upper edge 43 of the window facing the slide 28 is exposed. Otherwise, all of the remaining components of the actuating apparatus 1 are in the position according to FIG. 7. When the pushbutton 3 is actuated by being pressed in the arrow direction according to FIG. 10, in this operating position there is no form-fitting or frictional connection between the pushbutton upper part 30 and the pushbutton lower part 31, so that the pushbutton upper part 30 can be displaced in the axial direction 14 relative to the pushbutton lower part 31. The pushbutton upper part 30 and the pushbutton lower part 31 are mechanically decoupled. The pushing according to FIG. 10 therefore merely causes the pushbutton upper part 30 to be displaced axially, so that the compression spring 6 is compressed. The pushbutton lower part “remains” in its starting position according to FIG. 9, so that an actuation of a lock mechanism (not shown) by the actuating element 8 does not occur and an extension of the actuating element 8 by the length l is therefore prevented. In this “empty stroke”, the latching projections 64 are lifted off from the lower edges 61. The latching projections 64 and the supporting projection 70 are guided between the side edges 42 of the windows 40 in the cylindrical tube section 32a and are displaced relative to the pushbutton upper part 30. Release of the pushbutton 3 enables the pushbutton upper part to be displaced by the compression spring 6 back into the starting position according to FIG. 9. In this position, an opening of a motor vehicle door or of the motor vehicle flap (not illustrated) is therefore not possible, since the actuating element 8 is mechanically decoupled from the pushbutton upper part 3.

In the operating position of the locking device 5 according to FIGS. 9 and 10, i.e. the operating position “central locking system closed”, the actuating device 3, 30, 31 can be mechanically coupled manually in a conventional manner by inserting the key into the lock cylinder 4 and rotating the same. After the key has been inserted into the lock cylinder 4, the rotating body 51 is rotatable. Rotation of the rotating body 51 about the axis 14 causes the eccentric nipple 53 to be moved from the position according to FIG. 9 (on the right of the longitudinal axis 14) into an open position (on the left of the longitudinal axis 14 (not shown)). By this means, the slide 78 is displaced from its position shown in FIG. 9 to the left, so that it comes to lie over the free edge 68 of the stop tab 67 of the pushbutton lower part 31. In this case, it can also displace the slide 28 if the latter is in the position according to FIG. 7 because the locking device 5 is preferably set up in such a manner that it can be displaced. In this position, pushing of the pushbutton 3 causes the actuating element 8 to be actuated, since the pushbutton upper part 30 is mechanically coupled to the actuating element 8 via the lock cylinder 4, the slide 78 and the stop tab 67 of the pushbutton lower part 31. An actuation of the lock can therefore be achieved purely manually even, for example, if the current should fail.

In the case of the actuating apparatus according to the invention, it is particularly advantageous that the latter is of particularly compact construction and permits the manual closing and opening and also a remotely actuable opening and closing. A further particular advantage is that the electrically controllable locking device 5 is designed in the manner of a module or cassette and is inserted into the handle body, and a variation of the actuating apparatus with and without a remote-controllable unlocking functionality can therefore be realized in a simple manner. By means of omission of the locking device 5 and by means of a simple closing of the slot-type recess in the handle body 2 by a cover or a panel (not shown), the actuating apparatus according to the invention can optionally be designed with and without a remote-triggering functionality. A costly installation, for example in a door body of a motor vehicle, as conventionally takes place, is unnecessary.

1-64. (canceled)

65. An actuating apparatus for a lock mechanism comprising a handle body, in which an actuating device for driving an actuating element for the lock mechanism is mounted in a handle-body end region, a moveable coupling link with which the actuating device can be brought out of operation, and a manually actuable coupling link being connected to a locking device having a remote-controllable driving device, the locking device is accommodated in subregions of the handle body.

66. The actuating apparatus as claimed in claim 65, wherein the driving device is a lifting motor connected to the coupling link via a pivotable reversing lever and a drag arm is connected between the reversing lever and the driving device.

67. The actuating apparatus as claimed in claim 66 wherein the driving device with the lever arm, the drag arm and the coupling link are accommodated in a housing, the housing being arranged in the handle body.

68. The actuating apparatus as claimed in claim 65, wherein the actuating device has a pushbutton with a lock cylinder, having an actuating longitudinal axis as longitudinal movement axis.

69. The actuating apparatus as claimed in claim 68, wherein the handle body, the pushbutton with the lock cylinder, the motor-driveable locking device, and an actuating element are acted upon by a compression spring.

70. The actuating apparatus as claimed in claim 68, wherein the handle body is substantially U-shape, having a base limb, a first U-limb and a second U-limb, the first and second each having end sides with which the handle body can be fastened to a door outer skin, the second U-limb includes along an actuating longitudinal axis, a plug-in opening for the pushbutton, the plug-in opening completely penetrates the second U-limb, and a receiving device having an substantially cylindrical outer shape extending away from the end side of the second U-limb.

71. The actuating apparatus as claimed in claim 70, further comprising an elongated blind-hole recess extending away form the plug-in opening to ever approximately ⅓ of the base limb of the handle body, said blind-hole recess is connected to a groove-type depression, which extends from an inside of the base limb and of the first U-limb as far as the end side of the first U-limb.

72. The actuating apparatus as claimed in claim 71, wherein the locking device is configured to plug into the blind-hole recess of the handle body and has a housing with a housing part and a housing cover, the housing is of a substantially L-shaped design and has a first limb which corresponds to the blind-hole recess in the base limb and a second limb which corresponds to the blind-hole recess in the region joining the blind-hole recess to the plug-in opening, a free end of the first limb having electric lines leading to an electric control element.

73. The actuating apparatus as claimed in claim 72, wherein the second limb includes, toward the plug-in opening, an outer surface which is designed in the shape of a section of a cylinder, whereby the plug-in opening and the outer surface is circular in cross section, with the slide projecting from the outer surface of the locking device for a distance into the plug-in opening.

74. The actuating apparatus as claimed in claim 68, wherein the pushbutton further comprises a pushbutton upper part and a pushbutton lower part, the lock cylinder being inserted in the pushbutton upper part by means of clip connection, the pushbutton upper part has a sealing ring which interacts with the inside of the plug-in opening and seals off the gap between the pushbutton upper part and the plug-in opening.

75. The actuating apparatus as claimed in claim 74, wherein the pushbutton upper part has a cylindrical tube section and a compressive part, the cylindrical tube section being a thin-walled, cylindrical tube with an outside tube outside and a free annular end surface opposite the annular end surface, the compressive part being connected integrally to the cylindrical tube section, the compressive part being larger in outside diameter that the cylindrical tube section and having a stepped hole with the actuating longitudinal axis as the central axis, the stepped hole having grooves on the inside for receiving small lock plates of the lock cylinder.

76. The actuating apparatus as claimed in claim 75, wherein the cylindrical tube section further comprises window-type cutouts which lie opposite each other in each case, with a lower edge, two side edges and an upper edge, the two window-type cutouts having the same dimensions in terms of area, and the lower edge and the upper edge each being arranged parallel to the annular end surface, with the side edges being arranged parallel to the actuating longitudinal axis.

77. The actuating apparatus as claimed in claim 68, wherein the lock cylinder further comprises a blocking body and a rotating body, with small lock plates being mounted in the blocking body, the blocking body having a torsional projection, the rotating body has, eccentrically with respect to the actuating longitudinal axis, an eccentric nipple which protrudes in the axial direction from the rotating body.

78. The actuating apparatus as claimed in claim 76, wherein the pushbutton lower part has a punch section and a tube section, punch section having, along the actuating longitudinal axis, at a free end of the punch section a threaded hole for receiving the actuating element, the tube section having an outside diameter which corresponds to the inside diameter of the cylindrical tube section of the pushbutton upper part, the tube section extends away from the punch section and, corresponding to the window-type cutouts has latching projection which are dimensioned, in such a manner that they can interact with the lower edge of the window-type cutouts and which are dimensioned in such a manner that they can be moved up and down in the window-type cutouts, guided by the side edges.

79. The actuating apparatus as claimed in claim 78, wherein the tube section has end steps, the end steps serving to support a slide guide, one of the latching projections has a stop tab as an extension of the tube section, the stop tab shaped in the form of a section of a cylindrical tube, and having a free end edge and side edges in the longitudinal direction adjacent to the associated latching projection, the stop tab has a stepped shoulder which has a step upper side in the form of a section of a circular ring.

80. The actuating apparatus as claimed in claim 79, wherein the pushbutton upper part, the pushbutton lower part and the stepped shoulder are situated in one of the window-type cutouts of the pushbutton upper part, the axial extent of the stop tab is shaped in such a manner that a gap is formed when the latching projection bears against the lower edge of the window-type cutouts.

81. The actuating apparatus as claimed in claim 79, wherein the slide guide has a base plate shaped in the form of a circular disk, the outside diameter of the slide guide corresponds approximately to the inside diameter of the punch section, spaced apart opposite one another, circular disk segments are integrally formed on the base plate, the circular disk sections are of thicker design than the base plate and have opposite, parallel guide surfaces which together with the base plate, serve for the displaceable mounting of the slide, the slide has flattened, opposite end edges which interact with the guide surfaces, thereby guiding of the slide between the circular dish sections, a U-shaped recess extends from one of the flattened portions into the interior of the slide and the lock cylinder having an eccentric nipple.

82. The actuating apparatus as claimed in claim 72, wherein the housing part is substantially L-shaped and channel-shaped and includes a housing base wall, a first L-shaped side wall, a second L-shaped side wall and an end side wall, the second L-shaped side wall having the outer surface near the plug-in opening, and the base wall has in the region of the first limb, a first base wall section and in the region, a second base wall section, the base wall sections are connected to a base wall curved section, and the first side wall has a first side wall section near the first limb, a second side wall section near the second limb and a side wall curved section in between, and preferably the second side wall has a first side wall section in the region of the first limb, a second side wall section in the region of the second limb and a side wall curved section in between the first side wall section and the side wall curved section, thereby forming a surface which is aligned with the surface of the handle body.

83. the actuating apparatus as claimed in claim 72, wherein the driving device, the motor axial drive and a piston rod are arranged near the first limb, the piston rod being connected via a transverse pin to a drag lever, the drag lever has, a slot-type recess in which a pin is mounted via which the drag lever and is connected to a reversing lever, the reversing lever having a hole with which the reversing lever is mounted pivotably on an axis which extends vertically away from the base wall, the reversing lever has a first lever arm and a second lever arm having a free end, the second lever arm of the reversing lever protruding from the axis into the second limb of the housing.

84. The actuating apparatus as claimed in claim 83, wherein the case of the axial drive, the drag lever and the lever arm of the reversing lever are arranged in near the first limb of the housing.

85. The actuating apparatus as claimed in claim 83, wherein the reversing lever has an actuating section near the free end of the second lever arm, the actuating section tapering toward the free end of the second lever arm and having a sliding surface which points in the assembly toward the plug-in opening.

86. The actuating apparatus as claimed in claim 83, wherein the second base wall section has an angled groove with a first groove limb and a second groove limb, the first groove limb running parallel to one actuating direction of the axial drive and the second groove limb running parallel to the actuating longitudinal axis and preferably at the free end of the first groove limb, the latter ends in the transition region between the base wall section and the second side wall section of the side wall and preferably a stop console for the slide is arranged aligned with the groove limb on the inside of the second side wall section.

87. The actuating apparatus as claimed in claim 83, wherein the side wall section has a recess from which the slide protrudes.

88. The actuating apparatus as claimed in claim 65, wherein the slide has a slide plate and a stop tab which extends vertically away from the end of the slide plate and the pushbutton having the pushbutton upper part with the cylindrical tube section each having an opposite widow-type cutout, the stop tab has a free edge and a width which is smaller that or equal to the width of the window-type cutout in the region of the other end of the slide plate, projections which in the assembly run in the angled groove are integrally formed on the slide plate.

89. The actuating apparatus as claimed in claim 86, wherein the angled groove in the base wall, an angled groove with a first angled groove limb and a second angled groove limb is formed in the cover.

90. The actuating apparatus as claimed in claim 85, wherein the slide includes a slide plate has an substantially square reach-through window through which the free end of the reversing lever reaches.

91. The actuating apparatus as claimed in claim 88, wherein the slide plate further comprises a slide projection having a channel in the form of a circular arc extending beyond the stop tab.

92. The actuating apparatus as claimed in claim 67, wherein the housing, in which the axial drive, the drag lever, the reversing lever and the slide are mounted, form the locking device which can be inserted into the handle body in the manner of a module.

93. The actuating apparatus as claimed in claim 75, wherein the actuating element acts upon the compression spring which at one end of the compression spring bears against a base wall of the receiving device and at the other end of the compression spring is connected to the annular end surface of the cylindrical tube section of the pushbutton upper part.

94. The actuating apparatus as claimed in claim 74, wherein the pushbutton lower part is connected by means of a clip connection to the pushbutton upper part in a manner such that they can be displaced axially in one direction with respect to each other.

95. The actuating apparatus as claimed in claim 73, wherein the pushbutton includes an upper part with a sealing ring, the pushbutton upper part being mounted in the handle body by means of the sealing ring and the plug-in opening in interaction with the outer surface.

96. The actuating apparatus as claimed in claim 74, wherein the pushbutton lower part reaches through a hole in the base wall of the receiving device and is connected to the actuating element.

97. The actuating apparatus as claimed in claim 89, wherein the reversing lever includes an actuating section in the area of the free end of the second lever arm with which reaches through the slide plate of the slide, the slide being guided in the grooves in the housing.

98. The actuating apparatus as claimed in claim 79, wherein the window-type cutouts of the pushbutton are arranged in such a manner that one of the window-type cutouts in which the stop tab of the pushbutton lower part is arranged, lies opposite the slide.

99. The actuating apparatus as claimed in claim 77, wherein the slide is in engagement with the eccentric nipple of the lock cylinder and can be displaced by said eccentric nipple.
